(19) United States
(12) Patent Application Publication
(10) Pub. No.: US 2004/0259754 A1
(43) Pub. Date: Dec. 23, 2004

(54) Method and apparatus for cleaning with intermediate concentration compositions

(76) Inventors: David W. Gohl, St. Paul, MN (US); Paul Mattia, Prior Lake, MN (US); David A. Fine, Minneapolis, MN (US)

Correspondence Address: MERCHANT & GOULD PC, P.O. BOX 2903, MINNEAPOLIS, MN, 55402-0903, US

(21) Appl. No.: 10/600,091

(22) Filed: Jun. 20, 2003

(51) Int. Cl. C11D 17/00

(52) U.S. Cl. 510/438

(57) ABSTRACT

The present invention relates to a method and an apparatus for cleaning an article with an intermediate concentration cleaning composition, and to the compositions. The method includes contacting the article with the intermediate concentration cleaning composition and then contacting the article with the composition diluted.

### FIELD OF THE INVENTION

The present invention relates to a method and an apparatus for cleaning an article with an intermediate concentration cleaning composition, and to the compositions. The method includes contacting the article with the intermediate concentration cleaning composition and then contacting the article with the composition diluted.

### BACKGROUND OF THE INVENTION

In typical conventional cleaning processes, removing tough soil requires pretreatment (pre-spray or pre-soak step), typically outside the cleaning (e.g., washing) machine or with a different composition. For example, conventional laundry processes employ a labor and time consuming pre-spotting of each individual stained piece of laundry before that laundry is placed in the washer. Conventional cleaning processes include substantially continuous addition of diluent to concentrate to form dilute use composition. For example, conventional laundry processes employ substantially continuous addition of water to fill the washer with use composition. Such machines cannot form or use a cleaning composition with a concentration intermediate that of the concentrate and the use composition.

There remains a need for a process and apparatus that provides contact with one or more intermediate level cleaning compositions for removing tough soil, improving cleaning, or providing superior treatment for a benefit, but without an added pretreatment step outside the cleaning apparatus.

### SUMMARY OF THE INVENTION

The present invention relates to a method and an apparatus for cleaning an article with an intermediate concentration cleaning composition. The method includes contacting the article with the intermediate concentration cleaning composition and then contacting the article with the composition diluted. In an embodiment, the method can include contacting an article with an intermediate concentration cleaning composition; diluting the intermediate concentration cleaning composition to form a dilute cleaning composition; and treating contacted article with the dilute cleaning composition to form a treated article. The present method can be applied to cleaning a variety of articles including laundry, wares, medical or dental instruments, hard surfaces, facilities and installations (cleaning-in-place), and the like.

In an embodiment, the present invention relates to an apparatus that can carry out the inventive method. Such a cleaning apparatus can include application system adapted and configured to contact an article with an intermediate concentration cleaning composition; fluid handling system adapted and configured to dilute the intermediate concentration cleaning composition with diluent to form dilute cleaning composition; and cleaning system adapted and configured to treat the contacted article with the dilute cleaning composition to form treated article.

### DETAILED DESCRIPTION OF THE INVENTION

Definitions

As used herein, the term “cleaning” includes a variety of ways of treating to improve the quality or appearance of an article or treating an article to provide a benefit (e.g., antimicrobial treatment; waxing or polishing; removing soap or salt films, scum or deposits; removing grit or grime; improving the finish or soil resistance of textiles; and the like). Cleaning laundry includes processes such as flushing, washing, finishing, antimicrobial treatment (e.g., sanitizing), extracting, rinsing, and the like. Cleaning can include reducing the population of microbes, such as through treating or contacting with an antimicrobial composition. Cleaning a hard or metal surface can include polishing the surface, removing corrosion from the surface, removing tarnish from the surface, and the like.

As used herein, the phrase “laundry item” refers to an item made from or including textile, woven fabric, non-woven fabric, or knitted fabrics. The laundry item can include natural or synthetic fibers such as silk fibers, cotton fibers, polyester fibers, polyamide fibers such as nylon, acrylic fibers, acetate fibers, and blends thereof including cotton and polyester blends.

As used herein, weight percent, percent by weight, % by weight, and the like are synonyms that refer to the concentration of a substance as the weight of that substance divided by the weight of the composition and multiplied by 100.

As used herein, the term “about” modifying the quantity of an ingredient in the compositions of the invention or employed in the methods of the invention refers at least to variation in the numerical quantity that can occur, for example, through typical measuring and liquid handling procedures used for making compositions in the real world; through inadvertent error in these procedures; through differences in the manufacture, source, or purity of the ingredients employed to make the compositions or carry out the methods; and the like. Whether or not modified by the term “about”, the claims include equivalents to the quantities.

Method

The present invention relates to a method for cleaning an article with an intermediate concentration cleaning composition. In an embodiment, the present method includes contacting the article with the intermediate concentration cleaning composition and contacting the article with a more dilute form of the composition.

For example, the method can include contacting an article with an intermediate concentration cleaning composition; diluting the intermediate concentration cleaning composition to form a dilute cleaning composition; and treating the contacted article with the dilute cleaning composition to form a treated article. An overall cleaning process can include use of more than one cleaning composition in a plurality of contacting, diluting, and treating procedures. For example, a laundry cleaning process can include a variety of procedures, such as flushing, washing, rinsing, bleaching, finishing, antimicrobial treatment (e.g., sanitizing), and extracting. The present method can be carried out at one or more of these procedures, such as flushing, washing, finishing, or extracting.

In an embodiment, the present method includes contacting an article with an intermediate concentration cleaning composition. Intermediate concentration cleaning composition refers to a composition that is more concentrated than the dilute composition used in treating. That is, the intermediate concentration cleaning composition can have a concentration at least about 2 times, at least about 3 times, at least about 5 times, at least about 10 times, at least about 20 times, at least about 40 times, at least about 100 times, at least about 200 times, at least about 400 times, or at least about 1000 times the concentration of the use composition. The intermediate concentration cleaning composition can have a concentration of active ingredients less than the concentration found in the concentrate produced by the manufacturer and/or shipped to the site of use. For example, the intermediate concentration cleaning composition can include a concentration of about 40 wt-%, about 30 wt-%, about 20 wt-%, about 10 wt-%, about 5 wt-%, about 3 wt-%, about 1 wt-%, or about 0.5 wt-% of the concentrate. In an embodiment, the intermediate concentration cleaning composition can include 100 wt-% of the concentrate. In an embodiment, the intermediate concentration is at about 1 wt-% to about 20 wt-%, about 2 wt-% to about 10 wt-%, or about 4 wt-% to about 6 wt-% concentrate cleaning composition, e.g., during contacting. In an embodiment, the intermediate concentration is at about 2 wt-%, about 5 wt-%, or about 10 wt-% concentrate cleaning composition, e.g., during contacting.

In an embodiment of the present method, the intermediate concentration cleaning composition is at a substantially constant concentration during contacting. That is, contacting according to the present method does not include a constant rate of dilution of a concentrate to a use composition (e.g., during filling of a standard home washing machine). The present intermediate concentration cleaning composition can have a concentration that remains within about 35%, 25%, 15%, or 10% of a particular value during contacting. 40+10 wt-% describes within 25% of 40 wt-%. By way of further example, the intermediate concentration cleaning composition can have a concentration of about 30 to about 50 wt-%, about 25 to about 35 wt-%, about 15 to about 25 wt-%, about 8 to about 12 wt-%, about 4 to about 6 wt-%, about 2.5 to about 3.5 wt-%, about 0.8 to about 1.2 wt-%, or about 0.4 to about 0.6 wt-% of a concentrate.

In an embodiment, the intermediate concentration is a substantially fixed or fixed concentration. In an embodiment, the intermediate concentration is a single concentration. In an embodiment, the intermediate concentration is substantially constant or constant during contacting.

Contacting can occur through any of a variety of known methods for contacting an article to be cleaned with a cleaning composition. For example, contacting can include spraying the article; immersing the article; pouring, brushing, scrubbing, wiping, foaming, misting, aerosolizing, or otherwise applying composition to the article; pumping composition into, onto, or through the article; or the like. Contacting can include circulating or recirculating the intermediate concentration cleaning composition. The present method can also include agitating the article with the intermediate concentration aqueous cleaning composition to form pretreated article. For example, contacting can include agitating.

In an embodiment, the present method includes contacting for about 1 min to about 16 hours, to about 8 hours, to about 4 hours, to about 2 hours, to about 1 hour, to about 30 min, or to about 15 min. In an embodiment, the present method includes contacting for about 1 min to about 20 min, about 2 min to about 10 min, or 4 to 6 min. In an embodiment, the present method includes contacting for about 2 min, about 5 min, or about 10 min.

The intermediate cleaning composition can be formed in any of a variety of ways known for forming a cleaning composition from a concentrate and a diluent. For example, the present method can include adding diluent and concentrate cleaning composition to a vessel to form an intermediate concentration cleaning composition. This method can also include ceasing adding diluent and concentrate cleaning composition to the intermediate concentration cleaning composition. For example, the present method can include a period of time of adding diluent followed by a period of time in which no diluent is added, which can in turn be followed by the diluting process. Alternatively, the present method can include a period of time of adding diluent at a first rate followed by a period of time during which no diluent is added or during which the diluent is added at a rate substantially below (e.g., only a small fraction of) the first rate. This can be followed by diluting at a rate comparable to the first rate.

Forming the intermediate cleaning composition can occur either within the apparatus that conducts treating or outside that apparatus. For example, the vessel can include a cleaning vessel of a cleaning apparatus. Alternatively, the vessel can include a dispenser vessel of a dispensing apparatus. For example, the present method can include mixing diluent and concentrate cleaning composition in a dispenser to form an intermediate concentration cleaning composition. Mixing can include agitating. This method can also include dispensing the intermediate concentration cleaning composition into contact with the article.

U.S. patent application Ser. No. 10/435,351, entitled DISPENSING APPARATUS AND METHOD SUITABLE FOR HETEROGENEOUS COMPOSITION, describes an apparatus suitable for forming the present intermediate concentration cleaning composition and dispensing it to a cleaning apparatus. This patent application and any patent or patents that issue from it are incorporated herein by reference in their entirety.

In an embodiment, the present method includes diluting the intermediate concentration cleaning composition to form a dilute cleaning composition. Contacting and diluting employ the same intermediate concentration cleaning composition. That is, the intermediate concentration cleaning composition employed for contacting is the same composition that is employed in diluting. The method includes diluting the intermediate concentration cleaning composition after contacting. Diluting can occur with mixing or agitation.

In an embodiment, a portion of the intermediate concentration cleaning composition can be removed after contacting. In such an embodiment, some or all of the removed intermediate cleaning composition can be saved and reused or recycled. For example, the removed intermediate concentration cleaning composition can be filtered and returned to a dispenser vessel.

In an embodiment, additional concentrate or other cleaning composition can be added after contacting. The additional concentrate or cleaning composition can be the same or different from the one used in the intermediate concentration composition. Addition of such additional concentrate or cleaning composition can result in a dilute composition with properties or contents different from the intermediate concentration composition.

In an embodiment, substantially all of or all of the intermediate concentration cleaning composition is retained and diluted to form the dilute cleaning composition. In an embodiment, diluting is conducted without adding additional or different concentrate or cleaning composition. Preferably, the present method does not include removing all of the intermediate concentration cleaning composition and replacing it with a use concentration composition.

In an embodiment, forming the intermediate concentration cleaning composition and diluting that composition are a stepwise process. That is, forming is complete or substantially complete before diluting begins. The flow of diluent into the composition can cease between forming and diluting. Such a stepwise process can include forming the intermediate concentration cleaning composition, contacting the article with that composition, ceasing adding diluent before or during contact, maintaining contact while adding has been ceased, then diluting to form the dilute composition. In an embodiment, diluent can flow into the composition during contacting at a second rate that is substantially below the rate at which diluent is added during diluting.

In an embodiment, contacting and diluting occur in the same apparatus, even in the same location, chamber, or bath. For example, contacting and diluting can both occur in the wash wheel of a horizontal axis washer. By way of further example, contacting and diluting can occur in the same portion of a tunnel ware washer.

Dilute cleaning composition refers to a typical use concentration cleaning composition employed in a cleaning process. For example, the dilute cleaning composition can be a wash or cleaning composition used in conventional laundry washing, ware washing, or clean in place applications. Such known compositions can include concentrate or active ingredients at concentrations of about 0.001 to about 2 wt-%, 0.01 to about 0.5 wt-%, about 0.3 wt-%, or the like. In an embodiment, diluting can include about 100 to about 2000-fold, about 200 to about 1000-fold, or 400 to 600-fold dilution of the intermediate cleaning composition to yield the dilute cleaning composition. In an embodiment, diluting can include about 200-fold, about 500-fold, or about 1000-fold dilution of the intermediate cleaning composition to yield the dilute cleaning composition. In an embodiment, diluting can include about 5 to about 200-fold, about 10 to about 200-fold, about 20 to about 100-fold, or 40 to 60-fold dilution of the intermediate cleaning composition to yield the dilute cleaning composition. In an embodiment, diluting can include about 3-fold, about 5-fold, about 10-fold, about 20-fold, about 50-fold, or about 100-fold dilution of the intermediate cleaning composition to yield the dilute cleaning composition.

In an embodiment, the present method includes treating the contacted article with the dilute cleaning composition to form a treated article. In an embodiment, contacting and treating occur in the same apparatus, even in the same location, chamber, or bath. For example, contacting and treating can both occur in the wash wheel of a horizontal axis washer. By way of further example, contacting and treating can occur in the same portion of a tunnel ware washer. The present method can include movement of the article within the cleaning apparatus. However, the present cleaning and treating processes do not include contacting (e.g., pretreatment) outside the cleaning apparatus followed by treating (e.g., cleaning) in the cleaning apparatus. For example, contacting does not include prespotting a laundry item outside of a washing machine followed by treating or washing the laundry item in the washing machine.

Treating can include any of a variety of known methods for treating or otherwise cleaning an article with a cleaning composition. For example, treating can include spraying the article; immersing the article; pouring, brushing, scrubbing, wiping, foaming, misting, aerosolizing, or otherwise applying composition to the article; pumping composition into, onto, or through the article; or the like. Treating can include circulating or recirculating the dilute concentration cleaning composition.

In an embodiment, the diluent includes or is a fluid. For example, the diluent can include or be a liquid solvent (e.g., an organic or aqueous solvent) or a gas. In an embodiment, the diluent includes or is an aqueous diluent. In an embodiment, the diluent includes or is water. In an embodiment, diluting includes diluting with water. In an embodiment, diluting includes diluting with aqueous diluent. In an embodiment, the present method includes wetting the article (e.g., with water or aqueous diluent) before contacting. Wetting can occur with moving or agitating the article.

In an embodiment, the present method includes contacting the article with a first intermediate concentration cleaning composition and contacting the article with a second intermediate concentration cleaning composition. For example, the second intermediate concentration cleaning composition can augment or (partially or entirely) neutralize the first intermediate cleaning composition. Contacting with the first and second compositions can form a third composition. This embodiment of the method can include diluting the second intermediate cleaning composition to form a dilute cleaning composition. This embodiment of the method can include diluting the first and the second intermediate cleaning compositions to form a dilute cleaning composition. This embodiment of the method can include diluting the third composition to form a dilute cleaning composition. This embodiment also includes treating the contacted article with the dilute cleaning composition to form a treated article. In an embodiment, contacting can employ three, four, or more intermediate concentration cleaning compositions.

In an embodiment, the present method includes first diluting including diluting concentrate cleaning composition with diluent to form an intermediate concentration cleaning composition. The intermediate concentration cleaning composition can include or have a concentration of about 0.1 to about 50 wt-% concentrate. This method can also include contacting the article for about 2 min to about 20 min with the intermediate concentration cleaning composition. Second diluting, e.g., diluting the intermediate concentration cleaning composition with the diluent, can form a dilute cleaning composition. The dilute cleaning composition can include or have a concentration of about 0.001 to about 2 wt-% concentrate. This embodiment can include treating the pretreated article with the dilute cleaning composition to form a treated article.

In an embodiment, the present method includes a method for washing an article. This method can include contacting the article with aqueous washing composition to form prewashed article; diluting the aqueous washing composition; and contacting the prewashed article with the diluted aqueous washing composition. For example, this embodiment can include contacting the article with intermediate concentration aqueous washing composition; agitating the article in the intermediate concentration aqueous washing composition to form prewashed article; diluting the intermediate aqueous washing composition to form dilute aqueous washing composition; and contacting the prewashed article with the dilute aqueous washing composition to form a washed article.

Methods for Cleaning Laundry

In an embodiment, the article cleaned in the present method includes or is laundry. Such a laundry cleaning method can include contacting the laundry with intermediate concentration cleaning composition; diluting the intermediate concentration cleaning composition to form dilute cleaning composition; and treating pretreated laundry with the dilute cleaning composition to form treated laundry. This laundry cleaning method can be carried out in any apparatus suitable for cleaning laundry. For example, the method can employ a horizontal axis washer, a top loading washer, or a continuous batch washer. In an embodiment, the method includes contacting and treating in the wash wheel of a horizontal axis washer. In an embodiment, contacting can include spraying the laundry with the intermediate concentration cleaning composition. Spraying can be conducted manually by a machine operator or automatically by the washer. Such contacting can occur in the wash wheel of a horizontal axis washer.

The present method can be carried out at any one of several stages of laundry cleaning. A commercial laundry cleaning process can include procedures such as flushing, washing, rinsing, bleaching, finishing, antimicrobial treatment (e.g., sanitizing), and extracting. For example, such a process can include flushing, washing, rinsing, bleaching, rinsing, rinsing, finishing, and extracting. Finishing includes procedures such as treating laundry with a sour, a softener, a polymer release agent, soil release or soil shield chemistry, antimicrobial agent (e.g., sanitizer), antiwrinkle agent, starch, or the like. The present method can be employed in any of these laundry cleaning procedures that includes applying a cleaning (e.g., washing, treating, finishing, or antimicrobial) composition. For example, the present process can be used in flushing, washing, bleaching, finishing, antimicrobial treatment (e.g., sanitizing), or extracting. For example, the present process can be used with a sour, a softener, or with a polymer release agent.

In an embodiment, the present method employs a cleaning composition including or that is a laundry flush composition, and treating includes flushing. In an embodiment, the present method employs a cleaning composition including or that is a laundry wash composition, and treating includes washing. In an embodiment, the present method employs a cleaning composition including or that is a laundry bleach composition, and treating includes bleaching. In an embodiment, the present method employs a cleaning composition including or that is an antimicrobial composition, and treating includes antimicrobial treatment. In an embodiment, the present method employs a cleaning composition including or that is a laundry finishing composition, and treating includes finishing. In an embodiment, the laundry finishing composition includes or is a sour, a softener, a polymer release agent, an antimicrobial agent (e.g., sanitizer), or a mixture thereof. In an embodiment, the present method employs a cleaning composition including or that is a polymer release agent, and treating includes flushing, washing, rinsing, finishing, or extracting. In an embodiment, the present method employs a plurality of these compositions and steps.

In an embodiment, the present method includes a method for flushing, washing, finishing, and/or extracting laundry. This method can be carried out in a horizontal axis washing machine. The method can include contacting the laundry with aqueous flush composition; rotating the laundry to form preflushed laundry; diluting the aqueous flush composition; contacting the preflushed article with the diluted aqueous flush composition; and rotating the laundry to form flushed laundry.

The method can include contacting the laundry with aqueous wash composition; rotating or agitating the laundry to form prewashed laundry; diluting the aqueous wash composition; contacting the prewashed article with the diluted aqueous washing composition; and rotating or agitating the laundry to form washed laundry. The method can include contacting the laundry with aqueous finishing composition; rotating or agitating the laundry to form prefinished laundry; diluting the aqueous wash composition; contacting the prefinished article with the diluted aqueous finishing composition; and rotating or agitating the laundry to form finished laundry.

In an embodiment of the present method directed to cleaning laundry, an intermediate concentration cleaning composition can be applied in the washwheel. Such an embodiment reduces water consumption compared to pre-treatment or extra step in wheel. This embodiment also reduces consumption of concentrate cleaning composition and eliminates need for another product in the cleaning cycle. Further, in this embodiment the total time that the laundry is contacted and treated can be less than the total time laundry is cleaned with a particular composition in a conventional process.

In an embodiment, the present invention can employ a horizontal axis washer. Contacting the laundry with intermediate concentration cleaning composition in a horizontal axis washer need not use so much composition that the composition can splash around with the laundry in the wheel. The laundry can be wetted with the composition with little composition to spare. For example, the laundry can be sprayed with the intermediate concentration composition. By way of further example, the laundry can be sprayed with water and then the cleaning composition (e.g., concentrate) can be added in an amount that yields the intermediate concentration cleaning composition.

Horizontal axis washers are typically described with respect to their laundry capacity in pounds. Aspects of certain embodiments of the present method can be described with respect to the amounts of cleaning compositions and diluent employed in a 35 lb. horizontal axis washer. In such a washer, wetting a load of laundry, for example in flushing, can employ about 1 (e.g., 100 fluid ounces or 3 liters) to about 2 gal. of water. Such volumes can also be employed in later washing, rinsing, bleaching, finishing, antimicrobial treatment (e.g., sanitizing), or like procedures to wet the laundry. However, after the load of laundry has been wetted for the first time, less water, for example, less than 1 gallon or about 0.2 to about 1 gallon, can be employed.

Employing a 35 lb. horizontal axis washer in an embodiment of the method of the present invention, the laundry can be wetted with about 0.5 to about 5 gallons or about 1 to about 2 gallons of intermediate concentration cleaning composition. Such an intermediate concentration cleaning composition can include about 1 to about 25 wt-%, about 1 to about 10 wt-%, about 5 to about 10 wt-%, or about 10 wt-% active or concentrate cleaning composition. Contacting can last for about 1 to about 15 minutes, about 2 to about 10 minutes, about 3 to about 6 minutes, or for about 5 minutes.

In this embodiment employing a 35 lb. horizontal axis washer, diluting can include bringing the volume of cleaning composition up to about 11 to about 13 gallons. This can provide a concentration of cleaning composition of about 0.3 wt-% active or concentrate cleaning composition. In an embodiment of the present invention, the total volume can be reduced to about 8 to about 10 gallons. In a method employing a horizontal axis washer, the method can include continuously pumping or recycling cleaning composition or water into the wheel via a door mounted sprayer.

Methods for Warewashing

In an embodiment, the article cleaned in the present method includes or is a ware or wares. Such a method for cleaning ware can include contacting the ware with intermediate concentration cleaning composition; diluting the intermediate concentration cleaning composition to form dilute cleaning composition; and treating contacted ware with the dilute cleaning composition to form treated ware. This method for cleaning ware can be carried out manually or in any apparatus suitable for cleaning ware. In an embodiment, the method includes contacting and treating in a ware washing machine. In an embodiment, the cleaning composition includes a warewashing composition, and treating includes washing. In an embodiment, the cleaning composition includes a rinse composition, and treating includes rinsing. In an embodiment, the cleaning composition includes an antimicrobial composition (e.g., sanitizer), and treating includes antimicrobial treatment (e.g., sanitizing).

Wares (e.g., instruments, utensils, cookware, tableware, carts, cages, and the like) can be cleaned either manually or with a machine. Manual cleaning can include preparing an intermediate concentration cleaning composition and applying it to the ware. Applying typically includes wiping or scrubbing the ware with a brush, a towel, or a sponge soaked with the cleaning composition; applying a foam or a gel to the ware; or soaking or immersing the ware. Applying can also include spraying the ware with the composition. The method of cleaning wares also includes diluting the intermediate concentration cleaning composition to achieve a dilute cleaning composition, and applying it to the ware.

Cleaning apparatus for smaller wares typically transport a basket or rack containing the wares through one or more chambers. The apparatus typically includes at least one chamber that houses the ware during washing, rinsing, and/or antimicrobial treatment cycles. In an embodiment, the apparatus carries out 2 to 4 different washing, rinsing, antimicrobial treatment, or other treating cycles. These cycles can include a pre-cleaning cycle including contacting, typically spraying, the ware with a pre-cleaning composition, e.g., an enzyme containing composition. If used, this pre-cleaning cycle precedes the washing cycle. The washing cycle includes contacting, typically spraying, the wares with a wash composition. A rinsing cycle can follow the washing cycle. The rinsing cycle includes contacting, typically spraying, the instrument with a rinsing composition.

These cycles can also include a lubricating cycle. The lubricating cycle includes contacting, typically spraying, the ware (e.g., instrument) with a lubricating composition, such as an oil based emulsion or “milk bath”. Lubricating oil based emulsions or milk baths are known to those of skill in the art. The pre-cleaning and/or lubricating steps can be conducted manually, with the apparatus conducting at least the washing and rinsing cycles.

Machine cleaning of larger wares can employ any of a variety of configurations of suitable cleaning apparatus. Such apparatus can be adapted to dispense the intermediate concentration cleaning composition employed in the methods of the invention. A cleaning apparatus for larger wares typically includes at least one chamber that houses the ware during washing, rinsing, and/or antimicrobial treatment.

Such an apparatus can include a single chamber sized to house, for example, 1-3 medical carts. Wares can be introduced into the apparatus by an operator through a door or other coverable opening in the chamber. The apparatus then subjects the carts in the chamber to one or more of washing, rinsing, antimicrobial treatment, and/or drying cycles. The one or more compositions can be applied by spraying. Drying can occur by blowing ambient or heated air, or by treating with steam. The wares can be removed from the chamber by an operator through the same door or other coverable opening or through an exit door or other coverable opening on an opposite side of the apparatus.

Apparatus for cleaning larger wares (e.g., larger or a larger number of carts of cages) can include a transport apparatus that transports one or several wares through one or more chambers including washing, rinsing, optionally antimicrobial treatment, and/or drying stations. Such an apparatus can resemble a touchless car wash sized and configured for cleaning the wares, e.g., medical carts, instead of cars. Typically wares such as carts are transported through the washing, rinsing, optional antimicrobial treatment, and/or drying stations by a track or rail apparatus while tipped at an acute angle from the horizontal, with its doors (if any) open. This tipping can keep the doors open and allow liquid to drain off any normally horizontal surfaces of a cart. The entry to such a larger apparatus can be covered, for example, by a door or with hanging plastic strips that allow entry of wares but that retain intermediate concentration and dilute cleaning compositions in the apparatus. The apparatus can be configured to spray the compositions on the wares. At the drying station, blowers blow ambient or heated air on the cart, or the cart is steam treated. Alternatively, the wares can be removed from the apparatus and towel dried. One or more stations can be at different, overlapping, or the same locations. The exit from the apparatus can be covered in the same manner as the entrance.

The present method of ware washing can include applying an intermediate concentration cleaning composition (e.g., a washing, rinsing, or antimicrobial composition) to the wares, for example, by spraying. This intermediate concentration cleaning composition can be diluted to form a dilute cleaning composition, which can then be applied to the wares.

Methods for Hard Surface Cleaning and Cleaning in Place

The present invention includes methods of using an intermediate concentration cleaning composition for hard surface cleaning and/or cleaning-in-place (CIP) procedures. In an embodiment, a method for cleaning in place or hard surface cleaning includes: contacting hard surface with intermediate concentration cleaning composition; diluting the intermediate concentration cleaning composition to form dilute cleaning composition; and treating contacted hard surface with the dilute cleaning composition to form treated article. In an embodiment, the method includes cleaning hard surfaces. In an embodiment, the method includes cleaning in place. In an embodiment, the article includes a hard surface, such as a hard surface of a facility. In an embodiment, the cleaning composition includes a washing composition, and treating includes washing. In an embodiment, the cleaning composition includes a rinse composition, and treating includes rinsing. In an embodiment, the cleaning composition includes an antimicrobial composition (e.g., sanitizer), and treating includes antimicrobial treatment (e.g., sanitizing).

In an embodiment, the cleaning compositions can be introduced into a cleaning system either manually or using an automatic metering and/or dispensing system. Diluent can be added before or after the cleaning composition is put into the system to form an intermediate concentration cleaning composition. This can be accomplished at ambient temperatures. The method includes contacting the system with the intermediate concentration cleaning composition. The intermediate concentration cleaning composition is then diluted to yield the dilute cleaning composition.

Cleaning-in-place (CIP) can be employed for cleaning larger facilities or installations than can be put through a cleaning machine. Clean in place refers to, for example, equipment (e.g., piping or tanks) designed to receive and process foods or beverages that is also provided with its own installed cleaning system. Such a cleaning system can include storage containers for cleaning composition, for prerinse, and post-rinse solutions and optionally for soiled water flowing back. The individual cleaning solutions can be delivered to the equipment to be cleaned through valve-controlled pipes and can be pump-circulated through the cleaning process. The CIP equipment can also include piping, spray devices, valves, sensors, and controls.

Cleaning in place can include circulating an intermediate concentration cleaning composition, and then a dilute cleaning composition through the system, which is then drained, and optionally, the system can be rinsed one or more times with potable water. Cleaning-in-place of processing equipment in the food- or beverage-processing industry can include pre-rinsing emptied equipment with water to remove residues of product. Pre-rinsing can be followed by cleaning, during which cleaning composition can be pumped from its holding tank through the equipment to be cleaned and back into the holding tank. The cleaning solution can be circulated until the required cleaning effect is achieved. Cleaning piping in CIP systems can employ pigs that can be pulled or pushed through the piping. In such an embodiment, the intermediate concentration cleaning solution can be retained between one or more pairs of pigs. Cleaning can be followed by rinsing to remove all traces of the cleaning solution from the processing equipment. Cleaning in place can also include circulating an antimicrobial composition (e.g., sanitizer) through the equipment.

Compositions

The present method can employ any of a variety of known compositions useful for cleaning or treating an article. For example, the method can employ a cleaning composition, a washing composition, a rinse composition, a finishing composition (e.g., a sour, a softener, or a polymer release agent), an antimicrobial composition, bleaching or oxidizing composition, or the like. Any of a variety of such known compositions can be employed provided that they can form an intermediate concentration composition and a dilute composition. In an embodiment, the intermediate concentration composition is a solution, emulsion, or stable suspension. The intermediate concentration composition can be, for example, in the form of a gas stream, foam, fluid, or aerosol. In an embodiment, the cleaning composition includes a mildly, slightly, or low alkaline detergent.

In an embodiment, the intermediate concentration composition includes a composition described in U.S. patent application Ser. No. ______ and entitled HETEROGENEOUS CLEANING COMPOSITION AND METHODS. The disclosure of this patent application and any patent or patents that issue from it are incorporated herein by reference in their entirety. In an embodiment, the intermediate concentration cleaning composition can include about, for example, 10 wt-% of such a composition.

Apparatus

The present method can be employed with any apparatus that is or can be configured to employ or to form and then dilute intermediate composition. The apparatus can include the dispenser described hereinabove.

In an embodiment, such a cleaning apparatus can include application system adapted and configured to contact an article with an intermediate concentration cleaning composition; fluid handling system adapted and configured to dilute the intermediate concentration cleaning composition with diluent to form dilute cleaning composition; and cleaning system adapted and configured to treat the contacted article with the dilute cleaning composition to form treated article. The application system can be a manual or an automatic system. In an embodiment, the application system includes a sprayer or a foam generator. Such a sprayer can include, for example, an aerosol sprayer, a handheld spray nozzle, or a machine mounted spray nozzle.

In an embodiment, the cleaning apparatus can be a horizontal axis washer. Such a horizontal axis washer can include a dispensing system, a sprayer, and a wash wheel. The dispensing system can be adapted and configured to dispense intermediate concentration cleaning composition to sprayer. The sprayer can be adapted and configured to spray intermediate concentration cleaning composition onto laundry in the wash wheel to produce pretreated laundry. The sprayer can be an automatic sprayer integral to the apparatus, or can be a manual sprayer external to the apparatus. The sprayer can be adapted and configured to, after an interval, spray water into the wash wheel to contact the pretreated laundry.

### EXAMPLES

The present method was tested in an embodiment for laundry washing. Standard stained swatches were subjected to contact with an intermediate concentration washing composition. The swatches were then treated with a dilute cleaning composition. In certain tests the intermediate concentration and dilute compositions included the same cleaning composition. In other tests, the intermediate concentration composition was of one cleaning composition and the dilute composition also contained a second cleaning composition. Soil removal was evaluated as reflectance of the swatch compared to a clean swatch or portion of the swatch. In such tests a 10% increase in soil removal was interesting.

In tests the soil removal ability of a cleaning composition was determined by washing with artificially soiled fabric swatches. The soiled swatches are purchased from a manufacturer or distributor (e.g. Test Fabrics, Inc., West Pittston, Pa.). Soil types such as olive oil, sebum, makeup, wine are characteristic of natural soils found in laundry applications.

Some tests were conducted with 1-2 gallons of intermediate concentration washing composition at 1.5, 2.5, 5, or 10 wt-% cleaning composition. The swatches were rotated in a horizontal axis washer for 5 min. Then, water was added to provide a volume of either 11-13 gallons or 8-10 gallons of the dilute wash composition. From this point a typical commercial wash procedure was followed - wash, break, bleach, rinse, sour, and extract.

In other tests, soiled swatches were contacted and treated with cleaning composition in a device such as a Terg-o-tometer (United States Testing Co., Hoboken, N.J.). The Terg-o-tometer is a laboratory washing device that consists of multiple pots that reside in a single temperature-controlled water bath, with overhead agitators under time and speed control. Wash test parameters include: wash temperature, wash duration, mechanical agitation, dose of cleaning composition, water hardness, wash formula, and cloth/liquor ratio.

After a test run, swatches were rinsed, dried and the reflectance was measured on a spectrophotometer, e.g. a HunterLab ColorQuest XE system. The % soil removal (SR) was calculated from the difference between the initial (before washing) lightness (L) value and the final L value (after washing):

$$SR = ( \frac{{L}_{w} - {L}_{uw}}{{L}_{0} - {L}_{uw}} ) \times 100 \%$$

where:

L_{w}=lightness of the washed swatch

L_{uw}=lightness of the soiled, unwashed swatch

L₀=lightness of the white swatch before soiling

Materials

Lipstick stained cotton swatches were obtained from Testfabrics Inc. as STC WRK 10LS. Makeup stained swatches were obtained from Testfabrics Inc. as STC CFT-17. Dirty motor oil (DMO) stained swatches were obtained from Testfabrics Inc. as style 7436 WRL. EMPA (Swiss Federal Laboratories for Materials Testing and Research) 104 (carbon black and olive oil) stained swatches were stained from Textile Innovators. DSB (dust, sebum, blended fabric) swatches were obtained from Scientific Services S/D Inc. as cotton PEDP 7435 WRL.

NSL-FA-1 detergent refers to a non-phosphate, low-alkaline laundry detergent. D-Limonene refers to a natural terpene solvent derived from citrus and including (R)-1-methyl-4-(1-methylethenyl)cyclohexene. Butyl cellusolve refers to a washing composition of ethylene glycol monobutyl ether. SP1B refers to a soy-based solvent. L2000XP refers to a high alkaline laundry detergent. FP1 refers to a phosphated, low-alkaline laundry detergent.

Results

The results reported in Table 1 were from a test that employed contacting with an intermediate concentration cleaning composition followed by washing with dilute NSL-FA-1 detergent (0.1 wt-%). The results are reported as % soil removal. The swatch was stained with lipstick.

TABLE 1
Soil Removal After Contacting with Intermediate Concentration
Cleaning Composition and Treating with Dilute NSL-FA-1

| Intermediate Concentration | | | | |
|---|---|---|---|---|
| Cleaning Composition | 1.25 wt-% | 2.5 wt-% | 5 wt-% | 10 wt-% |
| Control (Water) | 53% | 53% | 52% | 51% |
| NSL-FA-1 | | 58% | 64% | 77% |
| D-Limonene | | 59% | 63% | 75% |
| Butyl Cellusolve | | | 58% | 56% |
| SP1B | | | 61% | 63% |
| L2000XP | 64% | 67% | 82% | 94% |
| FP1 | | 56% | 66% | 78% |

The results reported in Table 2 were from a test that employed contacting with an intermediate concentration cleaning composition followed by washing with dilute FP1 detergent (0.1 wt-%). The results are reported as % soil removal. The swatch was stained with lipstick.

TABLE 2
Soil Removal After Contacting with Intermediate Concentration
Cleaning Composition and Treating with Dilute FP1

| Intermediate Concentration | | | | |
|---|---|---|---|---|
| Cleaning Composition | 1.25 wt-% | 2.50 wt-% | 5 wt-% | 10 wt-% |
| Control (Water) | 44% | 45% | 45% | |
| NSL-FA-1 | 49% | 57% | 56% | 68% |
| D-Limonene | 55% | 61% | 65% | 70% |
| Butyl Cellusolve | | | 53% | 47% |
| SP1B | 54% | 57% | 58% | 59% |
| L2000XP | 60% | 71% | 82% | 93% |
| FP1 | | 52% | 62% | 73% |

The results reported in Table 3 were from a test that employed contacting with an intermediate concentration cleaning composition followed by washing with dilute L2000XP detergent (0.1 wt-%). The results are reported as % soil removal. The swatch was stained with lipstick.

TABLE 3
Soil Removal After Contacting with Intermediate Concentration
Cleaning Composition and Treating with Dilute L2000XP

| Intermediate Concentration | | | | |
|---|---|---|---|---|
| Cleaning Composition | 1.25 wt-% | 2.50 wt-% | 5 wt-% | 10 wt-% |
| Control (Water) | 59% | 60% | 57% | 45% |
| NSL-FA-1 | | 63% | 67% | 85% |
| D-Limonene | | | 64% | 62% |
| Butyl Cellusolve | | | 64% | 51% |
| SP1B | | | 62% | 61% |
| L2000XP | 68% | 77% | 86% | 89% |
| FP1 | | 65% | 75% | 80% |

The results reported in Table 4 were from a test that employed contacting with an intermediate concentration cleaning composition (10 wt-%) followed by washing with a dilute cleaning composition (0.3 wt-%). The results are reported as % soil removal. The swatch was stained with lipstick.

TABLE 4
Lipstick Removal After Contacting with Intermediate Concentration
Cleaning Composition and Treating with Dilute Cleaning Composition

| Intermediate Concentration | Dilute Cleaning Composition (DCC) | | | |
|---|---|---|---|---|
| Cleaning Composition | | | | Average Across |
| (ICCC) | NSL | FP1 | L2000XP | Row (ICCC) |
| FP1 | 78% | 73% | 73% | 74% |
| L2000XP | 94% | 93% | 93% | 93% |
| SP1B | 63% | 59% | 59% | 61% |
| Butyl Cellusolve | 56% | 47% | 47% | 50% |
| Limonene | 75% | 70% | 70% | 72% |
| NSL-FA1 | 77% | 68% | 68% | 71% |
| Control (Water) | 51% | | 45% | 48% |
| Column Average (DCC) | 74% | 68% | 68% | X |

The results reported in Table 5 were from a test that employed contacting with an intermediate concentration cleaning composition (10 wt-%) followed by washing with a dilute cleaning composition (0.3 wt-%). The results are reported as % soil removal. The swatch was stained with makeup.

TABLE 5
Makeup Removal After Contacting with Intermediate Concentration
Cleaning Composition and Treating with Dilute Cleaning Composition

| Intermediate Concentration | Dilute Cleaning Composition (DCC) | | | |
|---|---|---|---|---|
| Cleaning Composition | | | | Average Across |
| (ICCC) | NSL | FP1 | L2000XP | Row (ICCC) |
| FP1 | 80% | 72% | 74% | 75% |
| L2000XP | 88% | 80% | 81% | 83% |
| SP1B | 76% | 70% | 70% | 72% |
| Butyl Cellusolve | 75% | 69% | 68% | 71% |
| Limonene | 76% | 72% | 69% | 72% |
| NSL-FA1 | 78% | 77% | 78% | 78% |
| Control (Water) | 79% | | 73% | 76% |
| Column Average (DCC) | 79% | 73% | 73% | X |

The results reported in Table 6 were from a test that employed contacting with an intermediate concentration cleaning composition (10 wt-%) followed by washing with a dilute cleaning composition (0.3 wt-%) (CORRECT??). The results are reported as % soil removal. The swatch was stained with dirty motor oil (DMO).

TABLE 6
DMO Removal After Contacting with Intermediate Concentration
Cleaning Composition and Treating with Dilute Cleaning
Composition

| Intermediate Concentration | Dilute Cleaning Composition (DCC) | | | |
|---|---|---|---|---|
| Cleaning Composition | | | | Average Across |
| (ICCC) | NSL | FP1 | L2000XP | Row (ICCC) |
| FP1 | 10% | 2% | 16% | 9% |
| L2000XP | 29% | 27% | 25% | 27% |
| SP1B | 13% | 12% | 22% | 16% |
| Butyl Cellusolve | 10% | 4% | 15% | 10% |
| Limonene | 21% | 24% | 30% | 25% |
| NSL-FA1 | 7% | 11% | 21% | 13% |
| Control (Water) | 3% | | 10% | 6% |
| Column Average (DCC) | 15% | 13% | 22% | X |

The results reported in Table 7 were from a test that employed contacting with an intermediate concentration cleaning composition (10 wt-%) followed by washing with a dilute cleaning composition (0.3 wt-%). The results are reported as % soil removal. The swatch was-an EMPA 104 (carbon black and olive oil) stained swatch.

TABLE 7
EMPA 104 Stain Removal After Contacting with Intermediate
Concentration Cleaning Composition and Treating with Dilute
Cleaning Composition

| Intermediate Concentration | Dilute Cleaning Composition (DCC) | | | |
|---|---|---|---|---|
| Cleaning Composition | | | | Average Across |
| (ICCC) | NSL | FP1 | L2000XP | Row (ICCC) |
| FP1 | 10% | 2% | 16% | 9% |
| L2000XP | 29% | 27% | 25% | 27% |
| SP1B | 13% | 12% | 22% | 16% |
| Butyl Cellusolve | 10% | 4% | 15% | 10% |
| Limonene | 21% | 24% | 30% | 25% |
| NSL-FA1 | 7% | 11% | 21% | 13% |
| Control (Water) | 3% | | 10% | 6% |
| Column Average (DCC) | 15% | 13% | 22% | X |

The results reported in Table 8 were from a test that employed contacting with an intermediate concentration cleaning composition (10 wt-%) followed by washing with a dilute cleaning composition (0.3 wt-%). The results are reported as % soil removal. The swatch was stained with mascara.

TABLE 8
Mascara Removal After Contacting with Intermediate Concentration
Cleaning Composition and Treating with Dilute Cleaning
Composition

| Intermediate Concentration | Dilute Cleaning Composition (DCC) | | | |
|---|---|---|---|---|
| Cleaning Composition | | | | Average Across |
| (ICCC) | NSL | FP1 | L2000XP | Row (ICCC) |
| FP1 | 56% | 36% | 61% | 51% |
| L2000XP | 75% | 66% | 71% | 71% |
| SP1B | 66% | 62% | 65% | 64% |
| Butyl Cellusolve | 56% | 58% | 59% | 58% |
| Limonene | 47% | 46% | 52% | 48% |
| NSL-FA1 | 58% | 49% | 68% | 58% |
| Control (Water) | 56% | | 59% | 58% |
| Column Average (DCC) | 60% | 53% | 63% | X |

The results reported in Table 9 were from a test that employed contacting with an intermediate concentration cleaning composition (10 wt-%) followed by washing with a dilute cleaning composition (0.3 wt-%). The results are reported as % soil removal. The DSB swatch was a blended fabric stained with dust and sebum.

TABLE 9
Dust and Sebum Removal After Contacting with Intermediate
Concentration Cleaning Composition and Treating with Dilute
Cleaning Composition

| Intermediate Concentration | Dilute Cleaning Composition (DCC) | | | |
|---|---|---|---|---|
| Cleaning Composition | | | | Average Across |
| (ICCC) | NSL | FP1 | L2000XP | Row (ICCC) |
| FP1 | 43% | 35% | 44% | 41% |
| L2000XP | 58% | 55% | 53% | 56% |
| SP1B | 48% | 46% | 46% | 47% |
| Butyl Cellusolve | 46% | 43% | 50% | 46% |
| Limonene | 38% | 39% | 47% | 42% |
| NSL-FA1 | 46% | 38% | 49% | 44% |
| Control (Water) | 31% | | 44% | 38% |
| Column Average (DCC) | 47% | 43% | 48% | X |

Conclusions

These results demonstrate that the present method effectively increases removal of stubborn lipophilic, oily, particulate, or greasy stains and soils.

We claim:

1. A method for cleaning article, comprising:
contacting the article with intermediate concentration cleaning composition;
diluting the intermediate concentration cleaning composition to form dilute cleaning composition; and
treating the contacted article with the dilute cleaning composition to form treated article.

2. The method of claim 1, wherein the intermediate concentration is a fixed concentration.

3. The method of claim 1, comprising a single intermediate concentration.

4. The method of claim 1, wherein the intermediate concentration is substantially constant during contacting.

5. The method of claim 4, wherein the intermediate concentration is at about 8 wt-% to about 12 wt-% concentrate cleaning composition during contacting.

6. The method of claim 1, further comprising maintaining the intermediate concentration at about 8 wt-% to about 12 wt-% concentrate cleaning composition during contacting.

7. The method of claim 1, wherein the intermediate concentration cleaning composition comprises about 8 wt-% to about 12 wt-% concentrate cleaning composition.

8. The method of claim 1, comprising contacting for about 2 to about 20 min.

9. The method of claim 1, further comprising:
adding diluent and concentrate cleaning composition to vessel to form intermediate concentration cleaning composition;
ceasing adding diluent and concentrate cleaning composition to the intermediate concentration cleaning composition.

10. The method of claim 9, wherein the diluent comprises water.

11. The method of claim 9, wherein the diluent comprises aqueous diluent.

12. The method of claim 9, wherein the vessel comprises a dispenser vessel of a dispensing apparatus.

13. The method of claim 9, wherein the vessel comprises a cleaning vessel of a cleaning apparatus.

14. The method of claim 1, further comprising:
mixing diluent and concentrate cleaning composition in a dispenser to form intermediate concentration cleaning composition; and
dispensing the intermediate concentration cleaning composition into contact with the article.

15. The method of claim 1, further comprising agitating the article with the intermediate concentration aqueous cleaning composition to form pretreated article.

16. The method of claim 1, wherein diluting comprises diluting with water.

17. The method of claim 1, wherein diluting comprises diluting with aqueous diluent.

18. The method of claim 1, wherein diluting comprises about 100 to about 2000-fold dilution of the intermediate cleaning composition to yield the dilute cleaning composition.

19. The method of claim 1, wherein diluting comprises about 200 to about 1000-fold dilution of the intermediate cleaning composition to yield the dilute cleaning composition.

20. The method of claim 1, wherein the article comprises laundry, the cleaning composition comprises laundry flush composition, and treating comprises flushing.

21. The method of claim 1, wherein the article comprises laundry, the cleaning composition comprises laundry wash composition, and treating comprises washing.

22. The method of claim 1, wherein the article comprises laundry, the cleaning composition comprises laundry finish composition, and treating comprises finishing.

23. The method of claim 1, wherein the article comprises laundry, the cleaning composition comprises antimicrobial composition, and treating comprises antimicrobial treating.

24. The method of claim 1, wherein the article comprises ware, the cleaning composition comprises a warewashing composition, and treating comprises washing.

25. The method of claim 1, wherein the article comprises ware, the cleaning composition comprises a rinse composition, and treating comprises rinsing.

26. The method of claim 1, wherein the article comprises ware, the cleaning composition comprises antimicrobial composition, and treating comprises antimicrobial treating.

27. The method of claim 1, wherein contacting and treating each comprise cleaning in place.

28. The method of claim 1, wherein the article comprises hard surface of facility.

29. The method of claim 1, wherein the cleaning composition comprises antimicrobial composition.

30. A method for cleaning laundry, comprising:
contacting the laundry with intermediate concentration cleaning composition;
diluting the intermediate concentration cleaning composition to form dilute cleaning composition; and
treating pretreated laundry with the dilute cleaning composition to form treated laundry.

31. The method of claim 30, comprising contacting and treating in wash wheel of horizontal axis washer.

32. The method of claim 31, wherein contacting comprises spraying the laundry with the intermediate concentration cleaning composition.

33. The method of claim 30, wherein the cleaning composition comprises laundry flush composition, and treating comprises flushing.

34. The method of claim 30, wherein the cleaning composition comprises laundry wash composition, and treating comprises washing.

35. The method of claim 30, wherein the cleaning composition comprises laundry finish composition, and treating comprises finishing.

36. The method of claim 30, wherein the cleaning composition comprises antimicrobial composition, and treating comprises antimicrobial treating.

37. A method for cleaning ware, comprising:
contacting the ware with intermediate concentration cleaning composition;
diluting the intermediate concentration cleaning composition to form dilute cleaning composition; and
treating pretreated ware with the dilute cleaning composition to form treated ware.

38. The method of claim 37, comprising contacting and treating in ware washing machine.

39. The method of claim 37, wherein the cleaning composition comprises warewashing composition, and treating comprises washing.

40. The method of claim 37, wherein the cleaning composition comprises rinse composition, and treating comprises rinsing.

41. The method of claim 37, wherein the cleaning composition comprises antimicrobial composition, and treating comprises antimicrobial treating.

42. A method for cleaning in place, comprising:
contacting hard surface with intermediate concentration cleaning composition;
diluting the intermediate concentration cleaning composition to form dilute cleaning composition; and
treating pretreated hard surface with the dilute cleaning composition to form treated article.

43. A method for cleaning article, comprising:
first diluting comprising diluting concentrate cleaning composition with diluent to form intermediate concentration cleaning composition, the concentration of the intermediate concentration cleaning composition being about 5 to about 20 wt-% concentrate;
contacting the article for about 1 min to about 20 min with the intermediate concentration cleaning composition;
second diluting comprising diluting the intermediate concentration cleaning composition with the diluent to form dilute cleaning composition, the dilute cleaning composition being about 0.1 to about 0.5 wt-% concentrate; and
treating the pretreated article with the dilute cleaning composition to form a treated article.

44. A cleaning apparatus comprising:
application system adapted and configured to contact an article with an intermediate concentration cleaning composition;
fluid handling system adapted and configured to dilute the intermediate concentration cleaning composition with diluent to form dilute cleaning composition; and
cleaning system adapted and configured to treat the contacted article with the dilute cleaning composition to form treated article.

45. The apparatus of claim 44, wherein the apparatus is horizontal axis washer;
the washer comprising dispensing system, sprayer, and wash wheel;
the dispensing system adapted and configured to dispense intermediate concentration cleaning composition to sprayer;
the sprayer adapted and configured to spray intermediate concentration cleaning composition onto laundry in the wash wheel to produce pretreated laundry;
the sprayer adapted and configured to, after an interval, spray water into the wash wheel to contact the pretreated laundry.

46. The apparatus of claim 44, wherein the application system comprises sprayer or foam generator.

47. The apparatus of claim 46, wherein the sprayer comprises an aerosol sprayer, a handheld spray nozzle, or a machine mounted spray nozzle.

48. The apparatus of claim 44, wherein the application system is manual or automatic system.
